(19) United States
(12) Patent Application Publication
(10) Pub. No.: US 2009/0011087 A1
(43) Pub. Date: Jan. 8, 2009

(54) Process for the Manufacture of a Frozen Dessert and Frozen Dessert Thus Obtained

(75) Inventors: Jean-Luc Rabault, Pontheurard (FR); Jean-Marc Philippe, Leuville Sur Orge (FR)

Correspondence Address: PATZIK, FRANK & SAMOTNY LTD., 150 SOUTH WACKER DRIVE, SUITE 1500, CHICAGO, IL, 60606, US

(73) Assignee: COMPAGNIE GERVAIS DANONE, Paris (FR)

(21) Appl. No.: 12/281,278

(22) PCT Filed: Feb. 14, 2007
(86) PCT No.: PCT/IB07/00340

§ 371 Date: Aug. 29, 2008

Related U.S. Application Data
(60) Provisional application No. 60/781,296, filed on Mar. 10, 2006.

(30) Foreign Application Priority Data
Mar. 3, 2006 (FR) 0601938

(51) Int. Cl. A23G 9/04; A23C 9/127; A23G 9/20; A23G 9/46; A23G 9/36; A23G 9/40; A23G 9/32; A23C 9/12

(52) U.S. Cl. 426/61; 426/565

(57) ABSTRACT

A process is provided for the manufacture of a frozen dessert, comprising the successive steps consisting in: freezing an industrial milk composition comprising from 6 to 45% by weight of dry matter and fermented or nonfermented milk, the said composition not comprising both yoghurt and a fruit puree and/or juice, in order to obtain a frozen composition; optionally bringing the said frozen composition to a core temperature ranging from −15 to −25° C. or from −15 to −300 C, placing the said frozen composition in a device equipped with grinding means and optionally aerating means, and texturing the said frozen composition with the aid of the said grinding and optionally aerating means. It also relates to the frozen dessert thus obtained.

The present invention relates to a process for the manufacture of a frozen dessert either based on or not based on fermented milk, and the frozen dessert obtained.

Yoghurts are coagulated dairy products obtained by lactic acid fermentation by virtue of the action of thermophilic microorganisms derived from cultures of Streptococcus thermophilus and Lactobacillus delbruekii bulgaricus. They may also contain other lactic acid bacteria such as microorganisms derived from strains of Bifidobacterium animalis animalis and/or of Lactobacillus casei and/or of Lactobacillus plantarum and/or of Lactobacillus acidophilus. These lactic acid strains are intended to confer various properties on the finished product, such as a good balance of the human intestinal flora and better digestion of lactose and some of them have also proved their worth in the treatment of diarrhea disorders.

The probiotic properties of yoghurts make them a food of choice. However, they have two major disadvantages.

First of all, their best-before date is generally limited to 30 days after their date of manufacture, when they are stored at a temperature of between 1 and 10° C. They therefore have a short shelf life which can cause losses. Moreover, the advantageous properties of yoghurts are not available to people who refuse to consume them because they do not like their texture. These people also deprive themselves, for the same reason, of the nutritional benefits, and in particular of the supply of proteins and calcium, of unfermented fresh dairy products.

The need therefore remains to provide an alternative form of dessert having the advantageous properties of fresh dairy products and in particular of yoghurts, including their relative low calorie supply and their possible probiotic effects, but having nevertheless a texture which is markedly different and generally better accepted.

The Applicant has discovered that this need could be satisfied by subjecting certain commercially available fresh dairy products to a process which makes it possible to convert them to a frozen dessert having good organoleptic properties, in particular a texture that is creamy and not hard, without losing their nutritional benefits or increasing their energy value.

The frozen dessert thus obtained constitutes an advantageous alternative for consumers who do not crave fresh dairy products such as yoghurts, either because of their tastes, or because of climatic conditions which are more favorable to the consumption of frozen desserts. It is in fact well accepted that frozen desserts have a more refreshing effect than yoghurts because of the latent heat of fusion of ice, which is appreciable in hot countries such as Mexico or during some seasons.

More specifically, the process according to the invention may be carried out in an apparatus manufactured by the company PACOJET AG (Zug, Switzerland) and marketed under the trade name Pacojet by the company PACOCLEAN (Romagnieu—FRANCE).

In addition, this apparatus is already currently used by restaurant owners to manufacture ice creams. It is a multifunctional food processor which makes it possible in particular, according to the instructions for use of the apparatus and the recipes presented by the supplier on its Internet site, to manufacture frozen desserts based either on a mixture of cream and yoghurt, or of milk optionally mixed with cream, supplemented with fruit, coffee or spices. The mixture of these ingredients is introduced into a bowl which, after freezing, is mounted on the apparatus intended to grind (or “pacotize”) and possibly aerate the mixture, in order to obtain a creamy dessert whose texture resembles “soft ice” or Italian-type ice creams.

While the use of an apparatus of the type described above indeed makes it possible to easily prepare, at the scale of a restaurant, frozen desserts based on milk products, having a suitable texture and relatively acceptable nutritional properties, it is nevertheless the case that the fresh preparation of the mixture to be “pacotized” causes several problems.

In particular, in the case where the dessert has to contain fruit, this process causes constraints linked to the management of a stock of fresh fruit and to their preparation (washing, peeling, stoning, pasteurization, blanching).

In addition, the Applicant has demonstrated that frozen desserts with yoghurt and fruit, prepared from recipes based on UHT liquid cream or on fermented heavy cream, sometimes had a pronounced and/or rancid taste and a relatively soft texture. Without wishing to be bound by any theory, it appeared to the Applicant, in the light of the experiments which it carried out, that this disadvantage could be the consequence of an insufficient dispersion of the cream. Moreover, other experiments have shown that, when the mixture was sufficiently sheared before freezing so as to disperse the cream well, the dessert obtained after “pacotizing” had a texture that was too soft. Finally, the result of the above, and more generally of the fact that the characteristics of a freshly prepared mixture necessarily depend on human factors, is that the desserts obtained from these mixtures necessarily cause problems of reproducibility.

Now, the Applicant has demonstrated that the replacement of the abovementioned freshly prepared mixtures by certain commercial fresh dairy products made it possible to overcome the various disadvantages mentioned above. In particular, the industrial techniques used to disperse the cream that may be present in these products and the low shear applied in the factory to the viscous products ensure the production of a frozen dessert having a pleasant taste and a fairly firm texture. The constant composition and texture of these milk products additionally ensure good reproducibility of the dessert obtained from them.

It can thus be understood why the process developed by the Applicant, using certain fresh dairy products, makes it possible not only to overcome the problem of acceptability of milk desserts which some consumers encounter, and to avoid the loss of these fresh products beyond their best-before date, but also to offer restaurant owners, and more generally the users of apparatuses of the “Pacojet” type, a means which makes it possible to rapidly and reproducibly obtain frozen desserts having good organoleptic properties and a balanced nutritional profile, while being sufficiently firm to be able to be molded into balls.

The subject of the present invention is thus a process for manufacturing a frozen dessert, comprising the successive steps consisting in:
(a) freezing an industrial milk composition comprising from 6 to 45% by weight of dry matter and fermented or nonfermented milk, the said composition not comprising both yoghurt and a fruit puree and/or juice,
   in order to obtain a frozen composition;
(b) optionally bringing the said frozen composition to a core temperature ranging from −15 to −25° C. or from −15 to −30° C.,
(c) placing the said frozen composition in a device equipped with grinding means and optionally aerating means, and
(d) texturing the said frozen composition with the aid of the said grinding and optionally aerating means.

The subject of the present invention is also a frozen dessert which can be obtained according to the process described above.

As a preamble, it is specified that the process according to the invention may optionally comprise other steps that are preliminary or consecutive to those listed below, or even intermediate steps, as long as the nature and the order of the abovementioned steps are not altered.

The first step of the process according to the invention uses an industrial milk composition.

This expression is understood to mean a fresh dairy product manufactured on the industrial scale, that is to say in a plant which makes it possible to produce and package in closed containers generally bearing a best-before date and which can be stored at a temperature of the order of 1 to 10° C. at least several hundreds, or even several thousands, or even several tens of thousands, of 125 g units per day (or equivalent mass) of the said composition. Such a composition is usually available for sale away from its site of manufacture, generally through a distribution network involving at least one wholesaler and/or retailer and/or distributor and/or delivery agent.

In practice, in the industrial process for the manufacture of this composition, all precautions are taken to minimize the initial load and the growth of the undesirable microorganisms (that is to say which have not been deliberately inoculated).

To do this, the ingredients constituting the industrial milk composition are usually:
sterilized in the case of “neutral” products (pH>4.9), such as dessert creams, for example for one minute at 129° C., or
pasteurized in the case of acidic products (pH less than or equal to 4.9), such as yoghurts, fromage frais, products with fruit.

In the specific case of yoghurts, the pasteurization is followed by a fermentation step. Thus, the steps for preparing a yoghurt with fruit comprise in general: a mixture of ingredients, termed “white mass”, which is homogenized at high pressure, and then pasteurized (for example 95° C./6 min); and then steps of inoculation of selected ferments and fermentation. There may then be added to the white mass, according to an aseptic process, preparations containing fruit, sugars, sweeteners, flavors, colorings, texturants and the like.

The industrial milk composition thus obtained generally has a best-before date of twelve to forty-five days, preferably of thirty days, from its date of manufacture, provided that it is stored at a temperature ranging from 1 to 10° C., preferably from 1 to 6° C. Beyond this period, the quantity of spoilage or pathogenic microorganisms in the product may reach an unacceptable level.

This is a fundamental difference with dairy products prepared in domestic kitchens or by restaurant owners.

Consequently, another way of characterizing such an industrial milk composition consists in referring to its microbiological composition.

More specifically, it is preferable that the industrial milk composition used according to the invention contains a quantity of microorganisms such that:
when it has a pH greater than 4.9, the said industrial milk composition contains less than 5 cfu of total mesophilic microbes/g after incubation, measured by the following test: incubate x pots for 24 h at 30° C., then enumerate according to the NF V08-051 standard (3 days/30° C.). The result must be <5/g for each of the incubated pots.
   x=(500 g/net weight of a pot), rounded off to the upper integer (for example, let the pots be 125 g or 150 g, then x=4), and
when it has a pH of less than 4.9, the said industrial milk composition contains no yeast or mold, measured by the following two tests:
   Test 1: incubate x pots (without opening them) for 48 h at 30° C., and then remove in a sterile manner 1 g representative of each pot and enumerate according to the NF V08-059 standard (after incubating for 5 days at 25° C.). The result must be 0 for all the pots.
   Test 2: incubate x pots (without opening them) for 14 days at 25° C. None of the pots must exhibit swelling (before opening of the pot), or molds or yeasts that can be detected visually or by the olfactory route (after opening the pot).

Examples of fresh dairy products that are available commercially and can be used as industrial milk composition (designated hereinafter more simply by “milk composition”) in the process according to the invention, are given in the examples below.

The milk composition used according to the invention has a dry matter content of between 6 and 45% by weight. This dry matter content makes it possible to obtain a compromise between the nutritional and organoleptic aspects, on the one hand, and the natural character, on the other hand, of the frozen dessert which will be obtained. Indeed, a lower quantity of dry matter corresponds in general to a product containing less sugar, which may in this case be replaced by a synthetic sweetener, while a quantity of dry matter greater than 45% results in general in the product having an excessively high calorific value. The quantity of dry matter contained in the milk composition preferably ranges from 10 to 45% by weight, more preferably from 10 to 35% by weight, better still from 10 to 28% by weight, and even better from 10 to 24% by weight, relative to the total weight of the composition.

In the case where the dry matter content in the milk composition is between 6 and 12% by weight, it will advantageously contain at least 3.0% by weight of proteins, relative to the total weight of the composition, or at least one food polymer other than a protein, such as for example inulin, fructooligo-saccharides (FOS), modified or unmodified starch, polydextrose or pectin.

The milk contained in the milk composition used in the first step of the process according to the invention may be fermented or nonfermented.

It is chosen in particular from the group consisting of pasteurized milk, concentrated milk, pasteurized semi-skimmed milk, concentrated semi-skimmed milk, pasteurized skimmed milk, concentrated skimmed milk, and mixtures thereof.

It may be cow's, goat's, sheep's, buffalo's, soy or oat milk, or mixtures thereof, in particular. Cow's milk is preferred for use in the present invention.

According to the present invention, it is preferable that the milk contained in the milk composition is at least partially made of fermented milk, preferably in the form of yoghurt or as a variant in the form of fromage frais. A fermented milk indeed makes it possible to obtain a frozen dessert having a more cohesive texture, better digestibility of lactose and, in the case of yoghurt, to provide live ferments.

The expression yoghurt is understood to mean a coagulated dairy product obtained by lactic acid fermentation by virtue of the action of thermophilic microorganisms derived from cultures of Streptococcus thermophilus and Lactobacillus delbruekii bulgaricus, from milk or dairy products. It is the presence of these two bacterial strains which characterizes the name yoghurt, in accordance with the definition of Codex alimentarius. These specific microorganisms are preferably viable, in an overall quantity of at least 10⁷ CFU/g at the best-before date, the abbreviations C.F.U meaning Colony Forming Unit.

In a wider sense, it is also possible to call yoghurt for the purposes of the present invention products comprising lactic acid bacteria, other than the microorganisms Streptococcus thermophilus and Lactobacillus delbruekii bulgaricus, and in particular microorganisms derived from the strains of Bifidobacterium animalis animalis and/or of Lactobacillus casei and/or of Lactobacillus plantarum and/or of Lactobacillus acidophilus. These lactic strains are intended to confer various properties on the finished product, such as a good balance of the intestinal flora of humans. In the finished product, the microorganisms are preferably in the viable state. They thus improve the digestibility of the dessert manufactured from the composition according to the invention and confer probiotic properties on it.

Such a yoghurt thus advantageously corresponds to the specifications of fermented milks and yoghurts of the AFNOR NF 04-600 standard and of the codex StanA-11a-1975 standard. The AFNOR NF 04-600 standard specifies, inter alia, that the product must not have been heated after fermentation. Furthermore, in a yoghurt, the dairy products and the dairy raw materials must represent a minimum of 70% (m/m) of the finished product.

It is preferable that, in the present invention, a large quantity of live lactic acid ferments remain after freezing. Thus, the milk composition used according to the invention preferably contains at least 10⁵, preferably at least 10⁶, or even at least 10⁷ bacteria per gram, chosen from: (a) Streptococcus thermophilus, (b) Lactobacillus delbruekii bulgaricus, (c) Bifidobacterium animalis animalis, (d) Lactobacillus casei, (e) Lactobacillus plantarum, (f) Lactobacillus acidophilus and mixtures thereof. Preferably, the bacteria contain a mixture of (a) Streptococcus thermophilus, (b) Lactobacillus delbruekii bulgaricus and optionally also (c) Bifidobacterium animalis animalis and/or (d) Lactobacillus casei and/or (e) Lactobacillus plantarum and/or (f) Lactobacillus acidophilus. The frozen dessert obtained from this composition advantageously has the same characteristics.

The milk composition preferably contains at least 0.5% of milk proteins, relative to the total weight of the composition, that is more than about 15% by weight of milk, for example in the form of yoghurt, relative to the total weight of the composition.

According to a preferred variant of the invention, the milk composition is free of nonfermented cream.

The expression “nonfermented cream” is understood to mean a milk enriched with fatty substances, containing at least 30% by weight of fatty substances, in general 35% and even up to 40% by weight of fatty substances, which is in general liquid, has a pH close to 6.4 and is not acidified by lactic acid ferments.

The absence of cream makes it possible in particular to manufacture frozen desserts with fewer calories.

The milk composition used according to the invention may also comprise, according to an advantageous embodiment of the invention, fruit in the form of pieces and/or of puree and/or juice.

The expression “fruit puree and/or fruit juice” is understood to mean a preparation which is more or less liquid depending on the nature of the fruit and/or the fineness of the grinding, prepared by grinding, pressing or otherwise extracting one or more fruits and optionally concentrating the ground product obtained and/or separating (such as filtering) the pips, akenes and/or all or some of the pulp, and/or flash pasteurization, the preparation containing no added sugar. Some commercial fruit purees contain added sugars, for example conventionally 10% sucrose, the added sugars will be counted as sugars and subtracted from the weight of the fruit puree, according to the present invention,

More specifically, the fruit preparation (fruit puree and/or juice) optionally contained in the milk composition consists of fruits having a size which is small enough to pass through a sieve having a square mesh 3 mm along the side, the said sieve being optionally rinsed with water during sieving in the case where the preparation is very viscous. The fruits retained on the sieve in this test are considered as being fruit pieces.

The milk composition used according to the invention preferably contains from 5 to 30% by weight, more preferably from 5 to 20% by weight of fruit, as fruit equivalent, relative to the total weight of the composition.

The quantity of fruit optionally used according to the invention is expressed as fruit equivalent. The expression “fruit equivalent” is understood to mean the percentage of fruit used, multiplied by the percentage of dry matter content of these fruits, divided by the native mean percentage of dry matter content of these same fruits. For example, in the case where the composition according to the invention contains 20% of a fruit puree concentrated twofold (that is to say from which half the water has been evaporated) and then sweetened 10%, the fruit equivalent will be: 20×0.9×2/1=36%.

The fruits may be chosen from: apple, banana, strawberry, peach, raspberry, mulberry, mango, kiwi, blueberry, blackcurrant, redcurrant, orange, cherry, fig, pear, apricot, coconut, passion fruit, guava, papaya, melon, litchi, pineapple, lemon, mandarin, cherry plum, grapefruit, grape, rhubarb and mixtures thereof, without this list being exhaustive.

As a variant or in addition, the milk composition according to the invention may contain one or more added sugars (other than those naturally present in the fruits when they are present) in a quantity such that the composition contains less than 35% by weight, preferably less than 25% by weight, more preferably less than 20% by weight of carbohydrates, relative to the total weight of the composition. It preferably additionally contains more than 3% by weight of carbohydrates, relative to the total weight of the composition.

The expression sugar is understood to mean, for the purposes of the present invention, any sweetening carbohydrate, preferably sucrose, glucose, fructose, invert sugar, honey, maltose, or mixtures thereof, in particular in a 50:50 ratio.

As a variant or in addition, the milk composition may contain at least one of the following constituents: additives (within the meaning of the Codex alimentarius), in particular texturants, emulsifiers, sweeteners, colorings, preservatives; flavors; eggs; and mixtures thereof.

The expression “texturants” is understood to mean the compounds which modify the texture of the products into which they are incorporated. Examples of texturants are: guar and carob flours; gum Arabic, xanthan gum and gellan gum; carrageenans; starches (native or modified); microcrystalline cellulose; gelatin; pectin; alginates (E400 to E405); agar; and mixtures thereof. The expression “emulsifiers” is understood to mean amphiphilic compounds characterized by their HLB (Hydrophilic Lipophilic Balance) value, in particular which are capable of stabilizing oil-in-water emulsions. Examples of food emulsifiers are lecithin and its derivatives present in particular in egg yolk; fatty acid mono- and diglycerides; and polysorbate 80. The expression “sweetener” is understood to mean products with a sweet taste, such as polyols (for example maltitol, sorbitol, lactitol, xylitol, isomalt, erythritol), intense sweeteners (such as aspartame, acesulfame K, saccharine and its salts, or sucralose), or tagatose and trehalose. The expression “colorings” is understood to mean compounds of natural or synthetic origin which are capable of giving, on their own, color to the composition. Example of food colorings are known in Europe under the codes E100 to E180. The expression “preservatives” is understood to mean compounds which inhibit the proliferation of microorganisms, in particular of yeasts and/or molds and/or bacteria, in particular Staphylococcus aureus, in the composition. Examples of food preservatives are sorbic acid and its salts (E200 to E203); benzoic acid and its salts (E210 to E219); sulfites and derivatives (E220 to E228); natamycin; nisin; and mixtures thereof. The expression “flavors” is understood to mean compounds of natural or synthetic origin which are capable, on their own, of modifying the taste of the composition. Examples of flavors are vanillin; natural vanilla extracts; essential oils of added citrus fruits; and mixtures thereof.

The presence of texturing additives, or even of other food polymers such as proteins or dietary fiber (additives such as polydextrose or ingredients such as inulin, in particular) is particularly desirable when the dry matter content of the milk composition is less than 12% by weight, so that the desert obtained from this composition has a sufficiently firm consistency.

Moreover, it is preferable that this composition contains added flavors, either in place of, or preferably as a supplement to the abovementioned fruits. Indeed, the latter make it possible to prepare milk desserts based on fruits which are cheaper and often less acid than the desserts having an equally intense fruity taste but which are exclusively prepared based on fruits. It should be noted that this variant of the invention therefore offers an additional advantage compared with the desserts prepared from the prior art milk recipes which are freshly prepared from fresh fruit.

It is additionally preferable that the milk composition is free of guar and carob flours, which are capable of giving a scarcely natural texture and taste to the frozen dessert.

On the other hand, the composition used according to the invention may advantageously contain one or more nonhydrogenated vegetable oils containing unsaturated fatty acids, such as sunflower, oleic rapeseed or oleic sunflower oil. For the acid products which do not require heating at more than 100° C., it will be possible to use oils which are more heat-sensitive such as safflower, soybean, evening primrose or borage oil, or more preferably one or more oils rich in fatty acids of the omega-3 type and optionally omega-6 type, having preferably a ratio of fatty acids of the omega-6 type to fatty acids of the omega-3 type of less than 5, such as nut, lupine, camelina, linseed, hemp, cranberry, Inca inchi, kiwi seed or rapeseed oils, preferably rapeseed oil because of its very neutral taste.

In the case where the milk composition contains nutritive oils as a partial or complete replacement for the milk fat, the frozen dessert obtained according to the invention will preferably have a content of fatty acids of the omega-3 type (as linolenic acid equivalent) greater than 0.3 g per 100 g of frozen dessert (for example provided by 3.3% of rapeseed oil). Preferably, the ratio of fatty acids of the omega-6 type to fatty acids of the omega-3 type will be less than 5, and preferably less than 33% of the calories provided by the dessert will be of lipid origin.

The milk composition used according to the invention advantageously has an energy value of less than or equal to 155 KCal/100 g, preferably less than 130 KCal/100 g, more preferably less than 100 KCal/100 g, or even less than 75 KCal/100 g or even less than or equal to 45 KCal/100 g, and preferably greater than 20 KCal/100 g.

In addition, it preferably contains:
from 0 to 7%, for example from 0.1 to 7% by weight, more preferably from 0.1 to 4% by weight, or even from 0.1 to 3.5% by weight, or even from 0.1 to 1% by weight of fatty substances, and/or
from 0.5 to 7%, preferably from 2 to 5% by weight of proteins, and/or
less than 35% by weight, preferably less than 25% by weight, more preferably less than 20% by weight, and preferably more than 3% by weight of carbohydrates,
   relative to the total weight of the composition.

The frozen dessert obtained from this composition therefore advantageously has the same calorific and nutritional values as the milk composition from which it is derived.

In particular, the low level of fatty substances contained in the milk composition makes it possible not only to reduce the daily intake of fat, which is in particular of interest for people with cardiovascular risks or a tendency to become obese, but also, from the organoleptic point of view, to give a more intense taste and color to the frozen dessert, in particular when it contains fruits.

In addition, the milk composition preferably has a pH ranging from 3 to 4.9, and more preferably from 3.5 to 4.6.

To carry out the first step of the process according to the invention, the milk composition will generally be frozen either in a four-star freezer for a period of at least 12 hours, as a guide, and preferably of at least 24 hours, or in a cell blowing a gas at −40° C. or less (a conventional or cryogenic cold tunnel or cell), for a more rapid deep-freezing, the latter alternative allowing better survival of the ferments which may be present, and less growth of the ice crystals which will then be easier to grind. Obviously, it is also possible to freeze the milk composition at intermediate temperatures.

This freezing step is preferably carried out so as to obtain a frozen composition having a core temperature of less than or equal to −15° C., preferably of less than or equal to −18° C. and generally greater than or equal to −40° C.

The frozen composition thus obtained has an optimum use by date of 3 to 12 months, or even of 18 to 24 months, at a maximum temperature of −18° C. This composition is generally very hard and cannot be sampled as it is, but will be used to manufacture a frozen dessert.

It may have been frozen at a temperature of approximately −18° C., in which case it will be used as it is. As a preferred variant, and as indicated above, the frozen composition may have been obtained, or even stored at a lower temperature of up to −40° C. or even to −80° C. The process may then comprise a step consisting in bringing the frozen composition to a core temperature ranging from −15 to −25° C., preferably from −18 to −25°. It is however preferred to bring the temperature to a core temperature in the range of from −15 to −30° C., preferably from −20 to −30° C. and more preferably from −24 to −30° C. These conditions allow to obtain, whatever the way the composition has been prepared and frozen, very small crystals which are almost imperceptible to the consumer.

The third step of the process according to the invention consists in placing the frozen composition described above in a device intended to texture it.

At this stage, the composition is generally packaged in the frozen state in a container which is particularly suited to the texturing device, in which either it was marketed before freezing, or into which it was poured before freezing, or it was introduced in the form of a frozen cartridge (having a form suited to the abovementioned container).

In the fourth step of the process according to the invention, the frozen composition is then textured in the abovementioned texturing device, which is equipped with grinding means and optionally with aerating means. Preferably, this device does not include any extrusion means.

Preferably, the grinding means comprise a grinding component equipped with rotating blades, mounted at the end of an axle which is adapted to move longitudinally, perpendicularly to the plane of the blades. In another embodiment, the grinding means provided with rotating blades, which is mounted at the end of an axle, is fixed and it is the pot which moves longitudinally, perpendicularly to the plane of the blades. For their part, the aeration means may consist of any means which makes it possible to supply air to the composition, generally under pressure. The texturing may also be performed at atmospheric pressure, in particular in order to obtain a frozen dessert having a color and/or a taste which are more intense and/or a texture which is denser and smoother, which is particularly advantageous for fruits with a lighter color and/or a milder taste, such as peach, or for compositions containing less than 2%, or even less than 1%, of fatty substances, or containing less than 15% dry matter content. The absence of aeration conferred on the latter type of composition indeed makes it possible to be able to then easily form balls having a smooth texture, without “holes”, in appearance and in the mouth.

Advantageously, the device additionally comprises means for varying the ratio of the speed of rotation of the blades to the speed of longitudinal movement.

A device of this type has been described in particular in Patent Application CA-2 250 542 and is for example marketed by the company PACOCLEAN under the trade name “Pacojet”.

This device makes it possible to grind the hard ice crystals and optionally to aerate them in order to obtain a frozen dessert having a smooth and melting texture and a temperature of −4 to −8° C.

It has the advantage of being simple to use, to occupy little space on the floor and to be sufficiently flexible to be able to texture various types of composition.

In the case where the milk composition has a low calorie content, that is to say when it contains less than 100, or even less than 75 KCal/100 g, it is preferable to subject it to two successive texturing operations, with or without aeration. The Applicant has indeed discovered that this type of milk composition, which has a low fat and sugar content, tends to form a powdery product after freezing and texturing, a fortiori if it contains no additive, and that this disadvantage could be easily overcome by immediately subjecting it to a second texturing in the abovementioned apparatus. A frozen dessert is thus obtained which has a fairly smooth and firm appearance, without the need to add additional fatty substances, sugars or polyols thereto.

The frozen dessert thus obtained is suitable for immediate sampling, in general within 10 minutes, for example in the form of balls or quenelles.

For organizational reasons, it may however be useful to store the dessert for longer before sampling. The process according to the invention may therefore comprise an additional step of storing the textured composition at a temperature of −18° C. for at most 90 minutes, preferably for at most 45 minutes. This time period may be extended by thermally insulating the pot containing the dessert, so as to slow down its cooling and thus the recrystallization of the frozen dessert.

According to a preferred variant, the process described above rather comprises the additional step of storing the textured composition at a temperature ranging from −6 to −12° C., preferably at a temperature in the region of −10° C. The highest temperatures of this range are rather suited to ventilated cold freezers and the lowest temperatures to static cold freezers. An example of apparatus which can be used to store the textured composition in the abovementioned temperature range is available from the company FRAMEC (Reventin-Vaugris, France).

This variant makes it possible to preserve the sensory properties of the frozen dessert for several hours—up to about three hours—after manufacture. Again, it is possible to thermally insulate the pot containing the dessert so as to slow down its cooling and thus extend the above time period. Beyond, if the texture of the dessert becomes too hard or “sandy” because of ice crystals which have become too big, it is preferable to freeze it again for at least about 10 hours at a temperature less than or equal to −18° C. and preferably between −24 and −30° C. before retexturing it.

The invention will now be illustrated by the following nonlimiting examples.

### EXAMPLES

### Example 1

### Preparation of Frozen Desserts According to the Invention

Ten desserts are prepared from milk compositions 1 to 10 below, according to the process described hereinafter.

Milk composition No. 1 (Danette pistachio Danone): whole milk and concentrated or powdered skimmed milk (83.1%), sugar, glucose-fructose syrup, thickeners (E1442, E407), cream (2.1%), lactose, starch, flavoring, colorings (E141, E160a).

Milk composition No. 2 (Yoghurt with fruit Creamy Recipe Danone Cherry plum): whole milk, sugar (9.9% on average), fruit pieces: cherry plum (6.6%), cream (1.8%), concentrated or powdered skimmed milk, milk proteins, glucose-fructose syrup, dextrose, thickeners: E1422, E440, E412, flavors, lactic ferments of yoghurt (S. thermophilus+L. bulgaricus).

Milk composition No. 3 (Petit Gervais with fruit Danone): pasteurized skimmed milk, pasteurized cream, sugar (10.9% on average), pureed fruit: raspberry, apricot, strawberry (6.2%), glucose-fructose syrup, thickeners: E1422, E1442, E410, E415, E412, calcium citrate, colorings: anthocyanins, paprika extracts, cochineal, beta-carotene, riboflavin flavors, lactic ferments, vitamin D.

Milk composition No. 4 (Low-calorie yoghurt with fruit Taillefine strawberry double zero): skimmed milk (66.8%), concentrated or powdered skimmed milk, strawberry pieces (12%), polydextrose (dietary fiber), flavor, colorings: E120, sweeteners: aspartame, acesulfame K, lactic ferments of yoghurt (S. thermophilus+L. bulgaricus).

Milk composition No. 5 (Low-calorie yoghurt with fruit Taillefine pineapple double zero): skimmed milk (71%), concentrated or powdered skimmed milk, pineapple pieces (8.5%), polydextrose (dietary fiber), flavor, sweeteners: aspartame, acesulfame K, E955, lactic ferments of yoghurt (S. thermophilus+L. bulgaricus).

Milk composition No. 6 (Low-calorie yoghurt with fruit Baiko strawberry zero, presented as a double layer: yoghurt on a bed of fruit): yoghurt containing 0% of fat (80%), fruit (12%), milk proteins, inulin, oligofructose (fiber), aspartame, acesulfame K, flavors, preservative for the fruit (E202).

Milk composition No. 7 (Low-calorie egg cream Taillefine vanilla flavor): skimmed milk, eggs (12%), sugar, thickeners: E1442, E415, cream (2.2%), powdered skimmed milk, vanilla flavor, coloring: E160a.

Milk composition No. 8 (Yoghurt cream mango Danone): whole milk, mango (18.5%), milk cream (14.9%), sugar (12.2%), concentrated or powdered skimmed milk, colorings: E160c, E160a, lactic ferments of yoghurt (S. thermophilus+L. bulgaricus), flavor.

Milk composition No. 9 (Danao peach-apricot drink): water, fruit juice based on concentrated juice 25.6% (peach-apricot), skimmed milk (16.5%), sugar, stabilizer: pectin, acidifier: citric acid, coloring: beta-carotene, flavors.

Milk composition No. 10 (Low-calorie Danao peach-apricot drink): water, fruit juice based on concentrated juice 29% (peach-apricot), skimmed milk (18.4%), stabilizer: pectin, fructose (0.8%), acidifier: citric acid, coloring: beta-carotene, flavor, sweeteners: aspartame, acesulfame K.

### Process of Preparation:

The above milk compositions 1 to 10 are commercially available. Straight after being taken out of the refrigerator, they were directly transferred from their sale packaging into pots sold with the Pacojet® apparatus, in an amount of 500 g per pot. These were then closed with a cover and frozen for 24 h and then stored for one month at −18° C.

On the day they were to be sampled, the boxes were placed in a standard Pacojet® apparatus (with or without aeration) in order to texture the frozen mixture. The grinding time was from 3 min 30 s+30 s and the final temperature was −6±2° C.

For recipes containing less than 90 KCal/100 g, the texture was very powdery (snowy) after the first texturing, and did not make it possible to form nice balls having a creamy and smooth texture. Surprisingly, a second texturing immediately after the first made it possible to obtain an optimum texture during sampling. The final temperature was then −3° C.±2° C. after these two texturing operations.

The ten frozen desserts thus obtained could be sampled immediately. To do this, balls were formed with a standard scoop directly in the pot containing the frozen dessert, and the balls were served in a cup, for example in an amount of two different balls per cup.

### Example 2

### Sensory Evaluation of the Desserts According to the Invention After Texturing Under Aeration

Ten frozen desserts were prepared respectively according to the process described in Example 1. The characteristics of the desserts thus obtained are described below.

Frozen dessert No. 1: The texture is rich with a good pistachio ice-cream taste. The second texturing makes it possible to obtain a mousse which is very aerated and very smooth, and which is very creamy in the mouth.

Frozen dessert No. 2: The texture is excellent and fairly firm. The product has the characteristic flavor and color of cherry plum, although not very pronounced.

Frozen dessert No. 3: The texture is quite creamy, typical of an ice cream. The strawberry taste is fairly pronounced.

Frozen dessert No. 4: After the second texturing, the texture is similar to that of an Italian-type ice cream, the taste is pleasant and the strawberry flavor is very well preserved.

Frozen dessert No. 5: After the second texturing, quite smooth nice balls are obtained which have a pleasant and very aerated texture. The taste is mild and resembles a pineapple sherbet although less sweet.

Frozen dessert No. 6: After the second texturing, very aerated balls are obtained which have a firm texture.

Frozen dessert No. 7: Nice balls are obtained which have an ice-cream appearance, a rich texture, is fairly thick and has a typical egg and vanillin taste.

Frozen dessert No. 8: The texture is very creamy and very smooth, the fruit pieces have been perfectly ground. The dessert has a nice mango taste identical to that of the milk composition used.

Frozen desserts Nos. 9 and 10: After the second texturing, very nice balls are obtained which have a very aerated texture and pleasant taste resembling sherbets.

### Example 3

### Sensory Evaluation of the Desserts According to the Invention After Texturing Without Aeration

The desserts 1 to 6 and 8 to 10 obtained in Example 1 were subjected to texturing without aeration as described in this example.

Compared with the desserts described in Example 2, the absence of aeration leads to desserts which can be more easily formed into balls having a nice appearance, in particular in the case of milk compositions containing less than 15% of dry matter content. The texture is harder and denser; the spoon impression is smoother, conferring a more creamy appearance on the dessert (in particular when it contains less than 1% of fatty substances), whose color and taste are moreover more intense.

Only the dessert obtained from the milk composition No. 8 is too hard without aeration to be able to be suitably molded into balls.

### Example 4

### Nutritional Values of the Desserts According to the Invention

Table 1 below groups together the nutritional values calculated for the desserts 1 to 10.

As is evident from this table, the dessert No. 10 has a particularly low calorie content, and given its very aerated character, makes it possible to obtain large balls of 35 g containing only 9.1 KCal each.

### Example 5

### Enumeration of the Live Ferments in the Frozen Dessert

Before freezing, the milk composition of Example 8 has a bacterial content of 2.2×10⁸ CFU/g, corresponding to the lactic acid bacteria obtained from fermentation.

A sample of the dessert obtained therefrom according to the process described in Example 1 was taken, refrozen at −18° C. and sent to an analytical laboratory in order to quantify the viable lactic acid flora. 5.6×10⁷ CFU/g were enumerated. This frozen dessert therefore contains live ferments for the purposes of the French regulations.

TABLE 1
Nutritional values

| | Dessert | Dessert | Dessert | Dessert | Dessert | Dessert | Dessert | Dessert | Dessert | Dessert |
|---|---|---|---|---|---|---|---|---|---|---|
| | 1 | 2 | 3 | 4 | 5 | 6 | 7 | 8 | 9 | 10 |
| kcal/100 g | 112 | 105 | 118 | 41 | 45 | 40 | 107 | 140 | 48 | 26 |
| Proteins % | 3.3 | 3.8 | 6.4 | 4 | 4.2 | 4 | 4.3 | 2.4 | 0.7 | 0.8 |
| Carbohydrates % | 18 | 15 | 15.2 | 6.1 | 6.8 | 4 | 18.1 | 17.7 | 11.2 | 5.5 |
| Lipids % | 3 | 3.3 | 3.5 | 0.1 | 0.1 | 0.1 | 1.9 | 6.6 | 0.1 | 0.1 |
| Fiber % | <0.2 | <0.2 | <0.2 | 3.4 | 1.5 | 2 | <0.2 | <0.2 | <0.2 | 0.2 |
| Dry matter % | 24.3 | 22.1 | 25.1 | 13.6 | 12.6 | 10.1 | 24.3 | 26.7 | 12 | 6.6 |
| Fruit % | 0 | 6.6 | 6.2 | 12 | 8.5 | 12 | 0 | 18.5 | 26 | 29 |
| Ferments (cfu/g) | 0 | >10⁷ | ~0 | >10⁷ | >10⁷ | >10⁷ | 0 | >10⁷ | 0 | 0 |

1. Process for manufacturing a frozen dessert, comprising the successive steps of:
(a) freezing an industrial milk composition comprising from 6 to 45% by weight of dry matter and fermented or nonfermented milk, said composition not comprising both yoghurt and a fruit puree and/or juice, in order to obtain a frozen composition;
(b) optionally bringing said frozen composition to a core temperature ranging from −15 to −25° C. or from −15 to −30° C.;
(c) placing said frozen composition in a device equipped with grinding means and optionally aerating means; and
(d) texturing said frozen composition with the aid of said grinding and optionally aerating means.

2. Process according to claim 1, wherein the quantity of dry matter contained in the milk composition ranges from 10 to 45% by weight, more preferably from 10 to 35% by weight, better still from 10 to 28% by weight, and even better from 10 to 24% by weight, relative to the total weight of the composition.

3. Process according to claim 1, wherein the milk contained in the milk composition at least partially consists of fermented milk, preferably in the form of yoghurt.

4. Process according to claim 3, wherein the milk composition contains at least 10⁵, preferably at least 10⁶, or even at least 10⁷ bacteria per gram, chosen from: (a) Streptococcus thermophilus, (b) Lactobacillus delbruekii bulgaricus, (c) Bifidobacterium animalis animalis, (d) Lactobacillus easel, (e) Lactobacillus plantarum, (f) Lactobacillus acidophilus and mixtures thereof.

5. Process according to claim 1, wherein the milk composition is free of nonfermented cream.

6. Process according to claim 1, wherein the milk composition comprises fruit in the form of pieces and/or juice and/or puree.

7. Process according to claim 6, wherein the milk composition contains from 5 to 30% by weight, more preferably from 5 to 20% by weight of fruit, as fruit equivalent, relative to the total weight of the composition.

8. Process according to claim 1, wherein the milk composition has an energy value of less than or equal to 155 KCal/100 g, preferably less than 130 KCal/100 g, more preferably less than 100 KCal/100 g, or even less than 75 KCal/100 g or even less than or equal to 45 KCal/100 g, and preferably greater than 20 KCal/100 g.

9. Process according to claim 1, wherein the milk composition contains:
from 0 to 7%, for example from 0.1 to 7% by weight, more preferably from 0.1 to 4% by weight, or even from 0.1 to 3.5% by weight, or even from 0.1 to 1% by weight of fatty substances, and/or
from 0.5 to 7%, preferably from 2 to 5% by weight of proteins, and/or
less than 35% by weight, preferably less than 25% by weight, and preferably more than 3% by weight of carbohydrates, relative to the total weight of the composition.

10. Process according to claim 1, wherein the grinding means comprise a grinding component equipped with rotating blades, mounted at the end of an axle which is adapted to move longitudinally, perpendicularly to the plane of the blades.

11. Process according to claim 10, wherein the device additionally comprises means for varying the ratio of the speed of rotation of the blades to the speed of longitudinal movement.

12. Process according to claim 1, wherein said grinding means comprise a grinding element provided with rotating blades, mounted at the end of a fixed axle, the pot being adapted for moving longitudinally, perpendicularly to the plane of said blades.

13. Process according to claim 1, wherein the step of texturing comprises two steps for texturing, optionally with aeration, the frozen composition.

14. Process according to claim 1, wherein the texturing is performed at atmospheric pressure.

15. Frozen dessert which can be obtained according to the process according to any one of claims 1 to 14.
